(19) United States
(12) Patent Application Publication
(10) Pub. No.: US 2007/0276728 A1
(43) Pub. Date: Nov. 29, 2007

(54) Software applications with embedded advertisements

(75) Inventor: Aravind Bala, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/441,598

(22) Filed: May 26, 2006

(51) Int. Cl. G06Q 30/00

(52) U.S. Cl. 705/14

(57) ABSTRACT

Systems and methods are provided to facilitate ad-funded software development. Advertisements are embedded in software applications based on the commands that the application supports. In one embodiment, developers, advertisers and/or software users are able to perform queries for commands. This capability simplifies the process of identifying instances of advertisements and/or opportunities for advertisements.

### BACKGROUND

Currently, one means for distributing software to consumers is through implementation of a licensing scheme. A typical software license is a contract that permits the licensee to use certain software in compliance with specified terms and conditions. The licensee may or may not pay for the right to use the software in accordance with the terms of the contract. Payment may or may not be financial in nature. An example of non-financial payment is a scenario wherein a consumer agrees to publish, for public consumption, improvements to a software application in exchange for the right to use the application in its current condition.

In some instances, a consumer pays for software up front before access is ever granted. In other cases, a consumer may be granted free access during a trial period that precedes an actual purchase of the same or similar product. The version of the software accessed during the trial period may be the same or different as compared to the version that is actually purchased. The trial version is sometimes a scaled down version of the actual purchased product. The examples provided herein are only a few of many schemes currently implemented to facilitate the distribution of software to consumers.

The Internet provides opportunities for other systems of software distribution. In fact, there is currently a trend toward providing some level of free online software functionality that is supplemented with advertisements. In this case, it is typically the advertisers rather than the consumers that compensate the sponsor of the software. One particular example of this is search engine advertising, where advertisers pay for ad placement relative to searches conducted by search engine consumers.

There is a possibility that, over time, software development will be more funded by advertisements than by consumers paying up for it up front. Thus, there is a need for systems and methods that facilitate ad-funded software development in a manner that is potentially appealing to software developers, advertisers and/or software consumers.

The discussion above is merely provided for general background information and is not intended for use as an aid in determining the scope of the claimed subject matter.

### SUMMARY

Systems and methods are provided to facilitate ad-funded software development. Advertisements are embedded in software applications based on the commands that the application supports. In one embodiment, developers, advertisers and/or software users are able to perform queries for commands. This capability simplifies the process of identifying instances of advertisements and/or opportunities for advertisements.

This Summary is provided to introduce a selection of concepts in a simplified form that are further described below in the Detailed Description. This Summary is not intended to identify key features or essential features of the claimed subject matter, nor is it intended for use as an aid in determining the scope of the claimed subject matter. The claimed subject matter is not limited to implementations that solve any or all disadvantages noted in the background.

### BRIEF DESCRIPTION OF THE DRAWINGS

FIG. 1 is a schematic block diagram of an advertising system that enables application commands to be leveraged as a basis for delivering advertising content to a user.

FIG. 2 is a simplified screen shot demonstrating one example of what a user might see when he or she encounters a command associated with an advertisement.

FIG. 3 is a diagrammatic representation demonstrating a spectrum of risk, from the perspective of software developers and advertisers.

FIG. 4A is a block flow diagram demonstrating, from a system perspective, steps for providing an advertisement-oriented alternative to command execution.

FIG. 4B is a block flow diagram demonstrating, from a system perspective, steps for providing an advertisement related to an executed command.

FIG. 4C is a block flow diagram demonstrating, from a system perspective, steps for providing advertising opportunities to a developer or publisher.

FIG. 4D is a block flow diagram demonstrating, from a system perspective, steps for providing advertising opportunities to advertisers.

FIG. 5 is a block diagram of a computing environment in accordance with an embodiment in which command searching and processing is performed on a client.

FIG. 6 is a flow diagram illustrating one embodiment of operation of the system shown in FIG. 5.

FIG. 7 shows one graphical user interface that can be used to receive entry of the search request.

FIG. 8A is a block flow diagram demonstrating, from a system perspective, generalized steps for providing an advertisement within a command-searching architecture.

FIG. 8B is a block flow diagram demonstrating, from a system perspective, generalized steps for enabling a developer to annotate application functionality.

FIG. 8C is a block flow diagram demonstrating, from a system perspective, generalized steps for enabling an advertiser to search for advertising opportunities.

FIG. 9 illustrates an example of a suitable computing system environment 900 in which embodiments may be implemented.

FIG. 10 is a block diagram of a mobile device, which is another exemplary computing environment.

### DETAILED DESCRIPTION

Users use commands in an application to complete tasks. Typically, commands are exposed to the user using graphic user interface (GUI) elements such as, but not limited to, menus, toolbars, and buttons. In some cases, commands may be exposed through implementation of hyperlinks. When a user executes a command using these and other types of devices, the application runs or executes code to facilitate completion of the associated task.

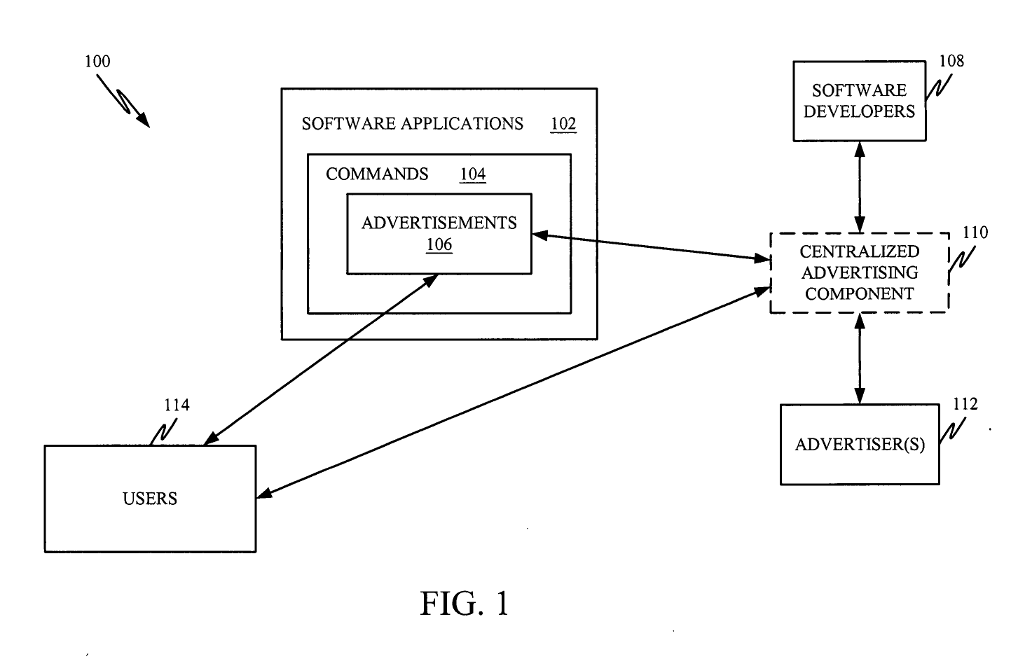

FIG. 1 is a schematic block diagram of an advertising system 100 that enables application commands to be leveraged as a basis for delivering advertising content to a user. Software developers 108 are illustratively entities or individuals responsible for the development of a software application 102. A software application 102 includes commands 104. At least one command 104 is associated with an advertisement 106.

Users 114 utilize a software application 102, and in doing so, encounter one or more commands 104. When a user 114 encounters a command 104 associated with an advertisement 106, then the user is presented with corresponding advertising content. Depending on implementation preferences, an ad can be configured to appear after the user has encountered the command element but prior to actual selection/execution of the command element or, alternatively, the ad can be configured to appear only after selection/execution of the command element. In one embodiment, the advertisement is presented prior to selection/execution and is intended as an alternative to selection/execution of the underlying command (e.g., a printing service advertisement is presented as an alternative to executing the underlying print command).

Advertisers 112 are illustratively the sponsors of advertisements 106. Those skilled in the art will appreciate that there are many ways to facilitate the relationship between users 114, developers 108 and advertisers 112. In one embodiment, a centralized advertising component 110 is provided. Within FIG. 1, component 110 is shown in dotted lines to emphasize that a centralized facilitation component such as component 110 is not necessarily required for implementation of the general scheme. However, component 110 is beneficial to the described system in that it can be configured to provide a centralized infrastructure for overall system functionality. This infrastructure can enable users 114 to find and use ad funded applications 102, enable advertisers to place ads on these applications, and/or enable software developers to distribute their applications and get advertisers to advertise on their application.

Centralized advertising component 110 is illustratively, but not necessarily, a software component (e.g., a web site accessible to users, developers and/or advertisers). Component 110 may be provided or sponsored by a developer 108, by an advertiser 112 and/or by an entity completely independent from developers 108 and advertisers 112. The infrastructure provided by component 110 may support implementation of a compensation scheme wherein advertisers 112 directly or indirectly compensate developers 108 for ad placement.

In one embodiment, centralized advertising component 110 facilitates the business relationships among users 114, developers 108 and advertisers 112. Component 110 can be configured to facilitate any of a variety of compensation schemes. For example, in addition to compensating a particular software developer 108 for ad placement, an advertiser 112 may also be required to compensate a sponsor of component 110 for the service of facilitating ad placement within an application 102. In one embodiment, it is a sponsor of component 110 that is responsible for compensating developer 108 on behalf of advertisers 112. In another embodiment, it is the developer 108 that is responsible for compensating the sponsor of component 110 on behalf of advertisers 112. Those skilled in the art will appreciate that these and other similar compensation schemes are within the scope of the present invention.

The functionality of component 110 is not necessarily limited to facilitating compensation. For example component 110 can be configured to facilitate intuitive processes for linking advertisements to commands. Further, advertising component 110 can be configured to enable multiple advertisers 112 to bid against each other in an auction (e.g., a real time auction) for the right to show advertisements in the context of certain identified applications and/or certain identified commands. For example, in one embodiment, through component 110, advertisers 112 can illustratively choose (or bid on) different commands from different applications depending on their advertising needs and preferences. Certainly it is contemplated that advertising component 110 can be configured to facilitate multiple advertisers advertising within the same application in association with the same or different commands. Those skilled in the art will appreciate the flexible nature inherent to the described advertising system 100.

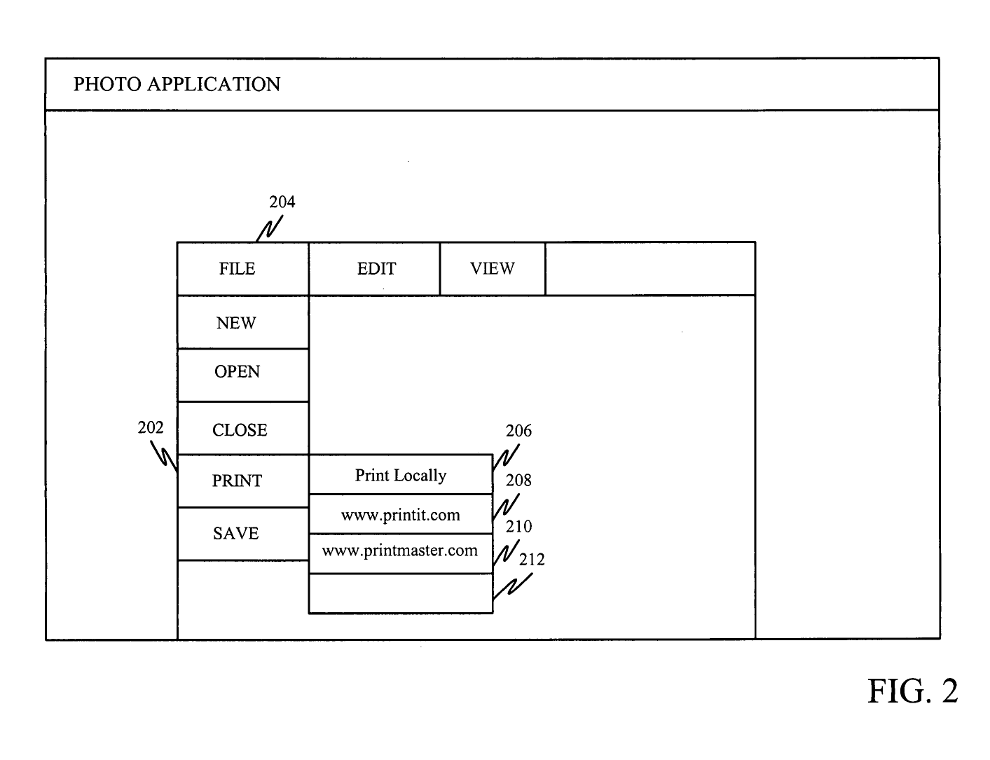

FIG. 2 is a simplified screen shot demonstrating one example of what a user 114 might see when he or she encounters a command 104 associated with an advertisement 106. In this case, the user has encountered a Print command 202 that appears in a File drop down menu 204 located within a photo application. Advertisements 208 and 210, which are hyperlinks associated with companies that print photos, are automatically presented as alternatives to selection/execution of a command 206 for printing on a local or network printer. In some cases, a system restriction may not allow multiple advertisements to be associated with a given command. In these cases, advertisers may be forced to bid against each other for the right to be associated with the command.

Selecting one of advertisements 206 and 208 illustratively routes the user toward options that are sponsored by an advertiser as alternatives to printing locally. Those skilled in the art will appreciate that the form of an advertisement 106 is not limited to simple execution of an Internet hyperlink such as links 208 and 210. In fact, an advertisement could lead to, and/or be encompassed within, a separate menu, dialog, system, wizard, etc. For example, when a user selects an advertisement 212 associated with a Print command 202, they may be presented with a complex, multiple-screen, printing wizard sponsored by a particular photo printing business. Thus, advertisers inherently have an incentive to add value to an application in order promote and/or sell products and/or services.

Any of a variety of different advertising business models can be employed to support the described command-oriented advertising within software applications. For example, a CPM (cost per thousand impressions) model can be employed such that an advertiser pays for advertisements when a user performs certain application commands. In general, the idea is that the advertiser pays whenever their ad is shown.

Another option is a CPC (cost per click) model. In this model, the advertiser pays only when their advertisement is selected (e.g., clicked on) by a user. In one embodiment, the price an advertiser pays is based on a “click-through” rate such that discounts or premiums can be applied depending how well targeted an add happens to be.

Another option is a CPA (cost per action) model. In this model, the advertiser pays only when a particular action is performed. For example, the advertiser pays only when a user signs up, orders a brochure, etc. Yet another option, which is similar to a CPA model, is an affiliate program or revenue share program, where an advertiser is willing to pay a percentage of their profit to anyone who sends them a customer.

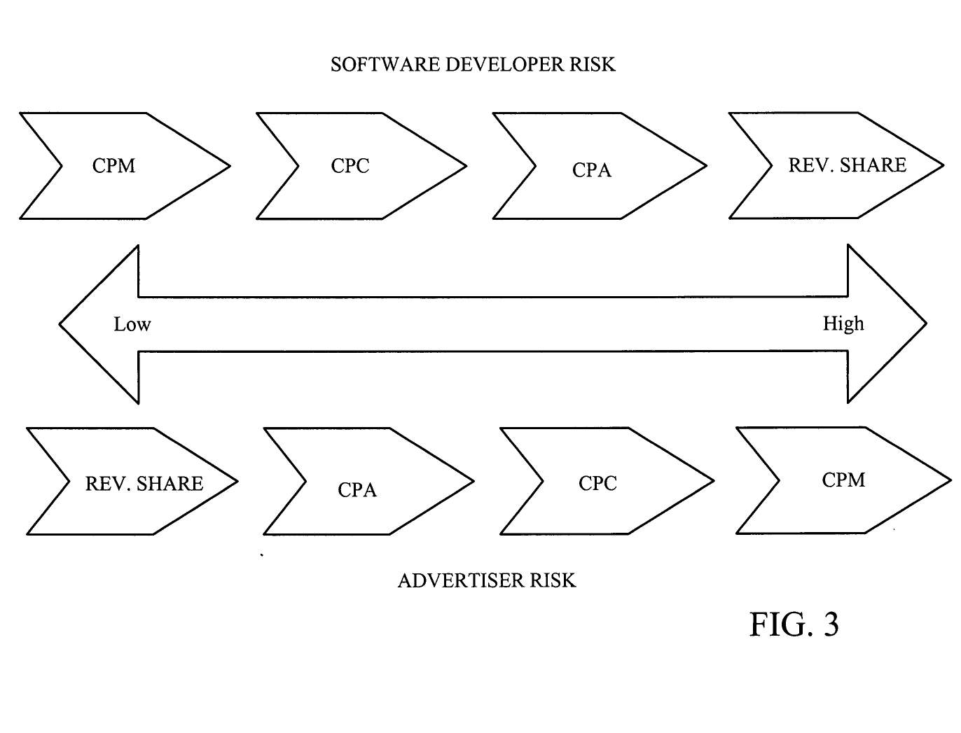

FIG. 3 is a diagrammatic representation demonstrating a spectrum of risk, from the perspective of software developers and advertisers, relative to different advertising business models that can be employed to support the described command-oriented advertising within software applications. As shown, CPM presents the highest risk for advertisers but lowest risk for software developers. Similarly, Revenue Share is the highest risk for software developers but lowest for advertisers. Software publishers of relatively popular software applications will likely be able to attract CPC or CPM pricing from advertisers, whereas software publishers of less popular applications may be forced to employ CPA or Revenue Share pricing.

In one embodiment, centralized advertising component 110 is configured to support transactions involving at least all of the described advertising business models. Those skilled in the art will understand that other models also exist and could just as easily be supported by component 110. In one embodiment, component 110 enables advertisers 112 and/or publishers 108 to make and/or review offers containing terms that reflect any of the described or other advertising business models.

Displaying advertisements within software applications 102 based on commands 104 encountered or executed by a user 114 is, in general, likely to be appealing from the perspective of users 114 at least because it does not require disclosure of any personally identifiable information. This is in contrast to content based advertising techniques that show ads based on the content of the user's work. For example, showing ads in an email application based on the content of the email. Command-specific advertising schemes do not necessarily require such tracking of a user's behavior or expressed interests.

In order to provide a better understanding of interaction within system 100, a few example scenarios will now be provided. In a first example scenario, a user named Joe (a user 114) wants to edit and print his photos from a recent vacation. He goes to an Internet web site (part of or associated with component 110) and searches for applications for editing photos. He finds a top rated photo application (application 102) called PhotoEdit 11.0 by Great Software Limited (a developer 108). He also reads reviews for it and learns that it is highly rated by other users.

Joe runs PhotoEdit, which runs inside his Internet browser application. The application allows him to edit his photos, remove “red eye,” and make his photos brighter. When he prints the photo on this computer, he is presented with an advertisement in a pop-up box that says “PRINT OUT ALL YOUR PHOTOS ONLINE FOR ONLY $2 USING PICTURE-CO-EXPRESS.” He clocks on that advertisement and uses the Picture-Co-Express printing service that will print out his photos and deliver them via postal mail. The URL for the PhotoEdit application is added to his application favorites within the browser application.

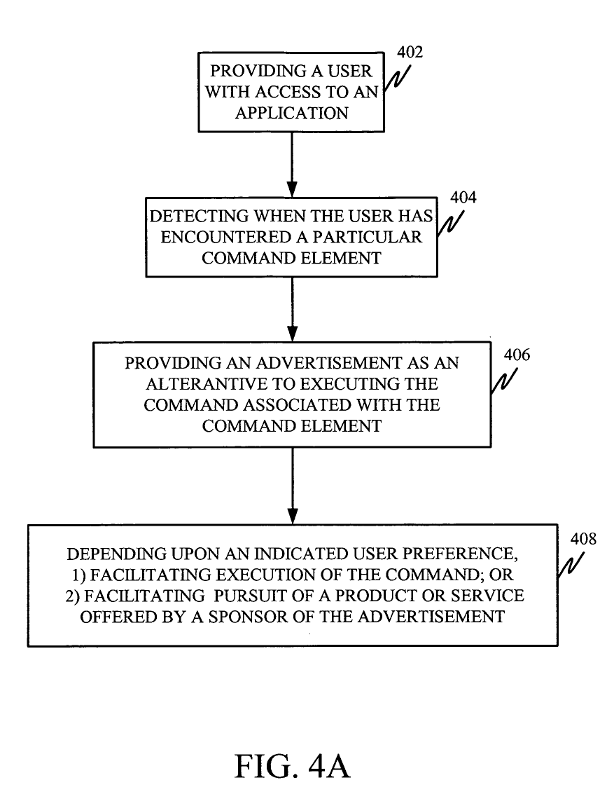

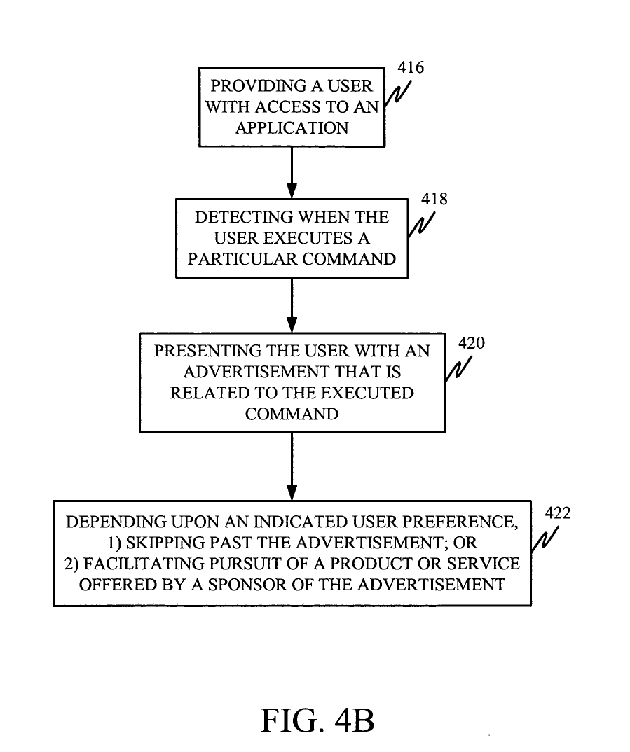

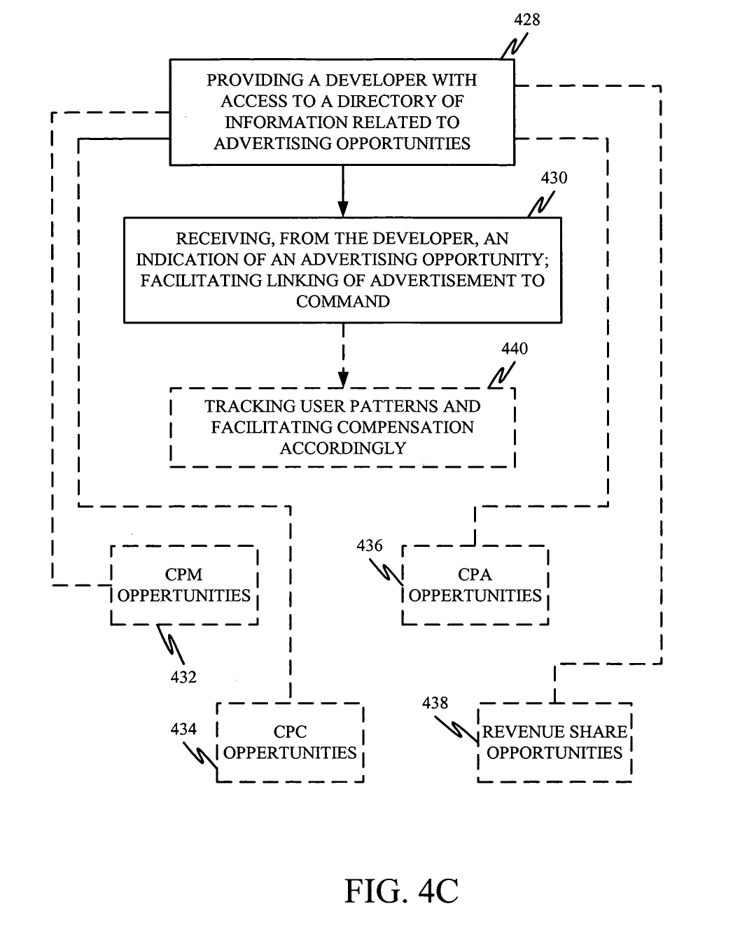

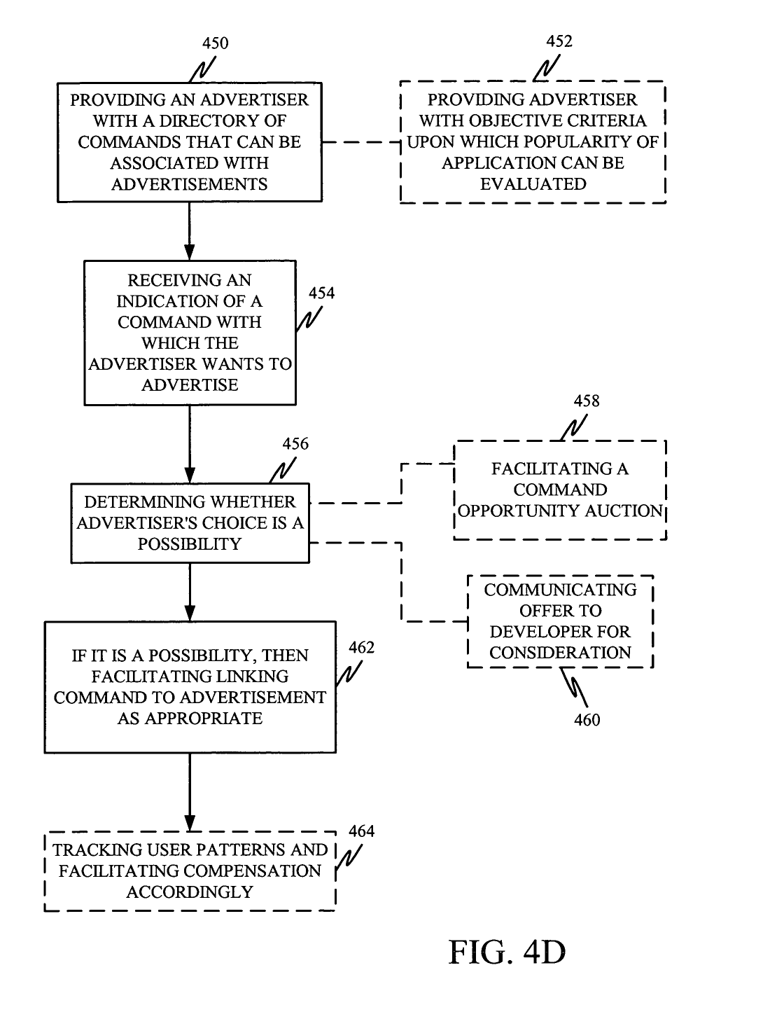

FIG. 4A is a block flow diagram demonstrating, from a system perspective, steps for providing an advertisement-oriented alternative to command execution. In accordance with block 402, a user is provided with access to an application. In accordance with block 404, there is a detection of an instance when the user has interacted with the application so as to encounter a particular command element. In accordance with block 406, upon detection, an advertisement is provided to the user as an alternative to executing the command associated with the command element. In accordance with block 408, depending on an indication received from the user, either 1) the command associated with the command element is executed; or 2) the system facilitates pursuit of a product or service offered by a sponsor of the advertisement associated with the command element.

In another example scenario, a lending company (advertiser 112) called “EZ Loans Today” purchases a targeted advertisement that causes a particular ad (advertisement 106) to appear when a user performs a “calculate tax refund” command (command 104) within a particular tax return program (application 102). The advertisement illustratively advertises an easy loan against the user's tax refund.

FIG. 4B is a block flow diagram demonstrating, from a system perspective, steps for providing an advertisement related to an executed command. In accordance with block 416, a user is provided with access to an application. In accordance with block 418, there is a detection of an instance when the user has selected a command element for execution of an underlying command. In accordance with block 420, upon detection, an advertisement is provided to the user as tangent functionality related to executing the selected command. In accordance with block 422, if the user indicates interest in the advertisement, the system facilitates pursuit of a product or service offered by a related sponsor.

In another example scenario, Dave, an independent software developer (developer 108), is passionate about photos and media. He is very good at programming in several different platforms and works in a bank in their IT department. He writes a graphics editing application (application 102) that is great for designing newspaper advertisements. He hears about an advertising platform (centralized advertising component 110) for enabling developers to advertise within their applications. He downloads a software development kit that enables him to integrate his software application with the advertising platform.

When Dave registers his application with the advertising platform, he illustratively chooses from different affiliate programs. From those programs, he then picks particular advertisements that he wants to show users of his application (NOTE: since in a revenue share deal there is virtually no risk to the advertiser—they generally don't mind who links to them). Because Dave's application involves designing banners and poster adds for print, he figures that users of his product might be interested in buying relevant books about good graphic design from an online bookstore called “Books-Today-Co.”. He picks a few links for books called “Designing Posters the E-Z Way,” “Great Graphic Design Principles,” etc. He wants these ads to show up whenever a more targeted ad is not shown.

Dave then goes through the commands that his application supports. For the “Print” command, he picks an affiliate link from a copy business and another link from a photograph business. For the “Save” command, he picks a link from “driveit.com”, a company that offers storage on the cloud. For the “More Commands” user interface element, Dave selects a link to an application for creating and modifying images. For other commands that are not linked to advertisements, the generic Books-Today-Co. ad or ads are shown. As Dave's application gains popularity, he starts making more and more money, which he receives in the form of payments from an entity associated with the advertising platform. As advertisers start to take notice, Dave may receive offers to embed advertisements in his application. These offers may reflect a compensation model other than an affiliate model.

FIG. 4C is a block flow diagram demonstrating, from a system perspective, steps for providing advertising opportunities to a developer, publisher, etc. In accordance with block 428, a developer is provided with access to a directory of information related to advertising opportunities. As indicated by block 432, 434, 436 and 438, the opportunities might be, but are not limited to, opportunities consistent with a CPM, CPC, CPA and/or revenue sharing business model. In accordance with block 430, an indication is received from the developer identifying one or more business opportunities selected from the directory. The system facilitates a linking of a command to an advertisement as appropriate. Block 440 is illustratively an optional step because its existence depends on how a given system is implemented. Block 440 includes tracking user interaction with the developer's application to determine when compensation is due based on a selected advertising opportunity. The system can also be configured to facilitate the actual compensation process.

In another example scenario, Tim is an Internet sales agent for a publishing company called Hruby Publishing Unlimited (an advertiser 112). Tim is responsible for increasing the sales of a new book called “Designing Great Posters.” He figures that by advertising on relevant software applications (applications 102), he can greatly increase sales of the book. He goes to an Internet site sponsored by an advertising platform for advertising within software applications (component 110).

Once on the Internet site, Tim searches for software applications related to “graphic design.” He finds that Dave's application is becoming very popular with his target audience. Tim decides to buy a premium spot on Dave's application. Because Dave is currently using an affiliate link from Books-Today-Co., Tim has to bid higher on a CPC spot to get his advertisement inserted in place of the link from Books-Today-Co. Also, Tim decides to place his advertisement on the “Help” command of Dave's application.

In another example scenario, Jill runs a small graphic design company (advertiser 112) that produces high quality templates and clipart data to be used on banners and in print articles. She decides to advertise within relevant software applications. Jill finds Dave's application (application 102) by searching through a directory associated with an advertising platform (advertising component 110). She bids on the “Apply Template” command in Dave's application and adds an Internet link that says “Get Professionally Designed Templates From Jill.com”.

FIG. 4D is a block flow diagram demonstrating, from a system perspective, steps for providing advertising opportunities to advertisers. In accordance with block 450, an advertiser is providing with a listing or directory of commands that can be associated with advertisements. The commands can be from different applications. In fact, in accordance with an optional step 452, an advertiser may be provided with objective criteria upon which the popularity of a given application can be evaluated to assist in making advertising decisions. In accordance with block 454, an indication is received and represents a command for which advertising is desired.

Next, in accordance with block 456, a determination is made as to whether the advertiser's choice is possible. In accordance with optional block 458, this could mean conducting an auction or bidding process to determine which of a limited number of advertisers will be allowed to advertise in association with a particular command. in accordance with block 460, a developer may be allowed to accept or rejection an advertiser's offer (e.g., offer may be a CPM, CPC, CPA, Revenue Share, or other type of offer).

In accordance with block 462, if the request for advertising is a possibility, then the system is illustratively configured to facilitate a linking of a command to an advertisement as appropriate. Block 464 is illustratively an optional step because its existence depends on how a given system is implemented. Block 464 includes tracking user interaction with the developer's application to determine when compensation is due based on a selected advertising opportunity. The system can also be configured to facilitate the actual compensation process.

The most popular software applications from the perspective of users are likely to be those that are the most user friendly and/or provide the best features. If more users use a particular application, that information can be tracked and reported by advertising component 110 (e.g., objectively reported to advertisers shopping for ad opportunities). More use will therefore logically lead to more advertising dollars, and so will give greater funding to software developers and/or publishers that continue to improve and refine their applications.

The present description will now transition to explaining how the described command-oriented advertising schemes can benefit from a searching component that enables commands associated with a computer program to be searched for and identified. An example of such a searching component will now be described in detail.

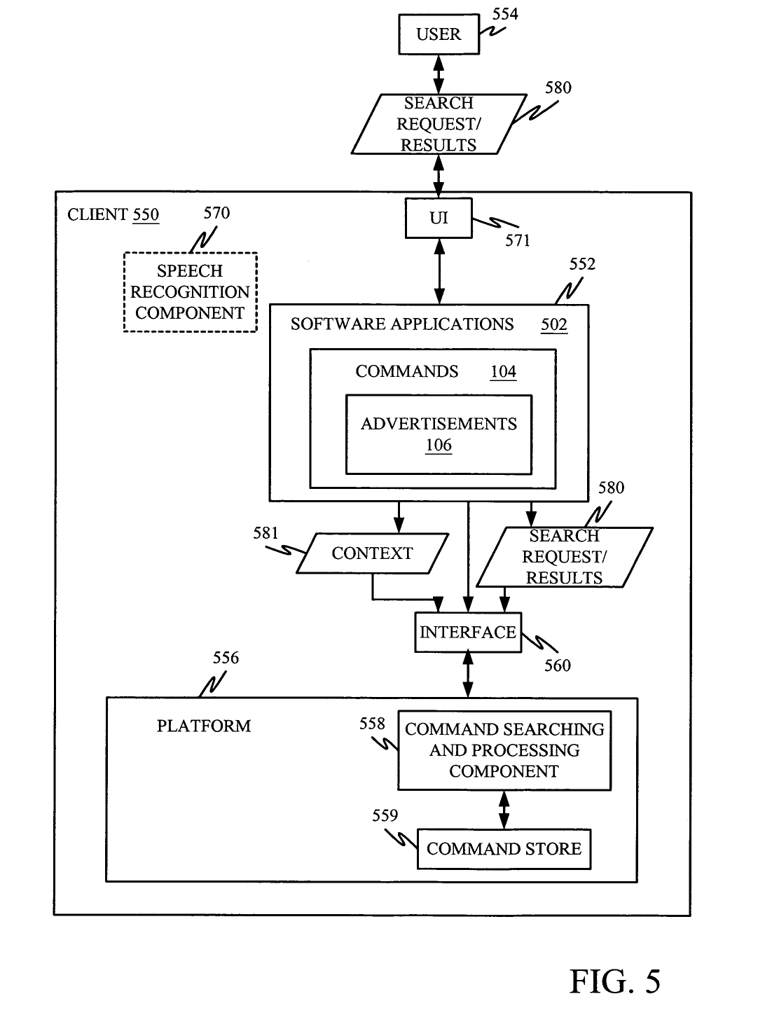

FIG. 5 is a block diagram of a computing environment in accordance with an embodiment in which command searching and processing is performed on a client 550. Client 550 is illustratively a desktop computer, a laptop computer, or a mobile device, such as a personal digital assistant, a telephone, a handheld computer, etc. In the embodiment shown in FIG. 5, client 550 has a software application 552 thereon which is accessed by user 554 such that the user can execute one or more commands to perform a variety of different tasks. For example, application 552 may be a word processing program, a spreadsheet program, a presentation program, or any other software application that can be accessed by a user 554, though a user interface 571, to perform tasks. Further, the application can either be a client application or a web based application. As is illustrated, application 552 is similar to application 102 in FIG. 1 in that it is configured to support command-oriented advertising.

Client 550 is shown with a platform 556. In one embodiment, platform 556 is, for example, an operating system that supports a plurality of different applications 552. In the embodiment shown in FIG. 5, platform 556 includes command searching and processing component 558 and command store 559. As is described in greater detail below, component 558 is exposed to user 554 through application 552 (or independent of application 552) such that the user can search for commands associated with application 552, and optionally execute the desired commands. In one embodiment, platform 556 exposes an interface 560, such as an application programming interface, which can be invoked by application 552.

Client 550 is also shown with an optional speech recognition component 570. This can be used as described below.

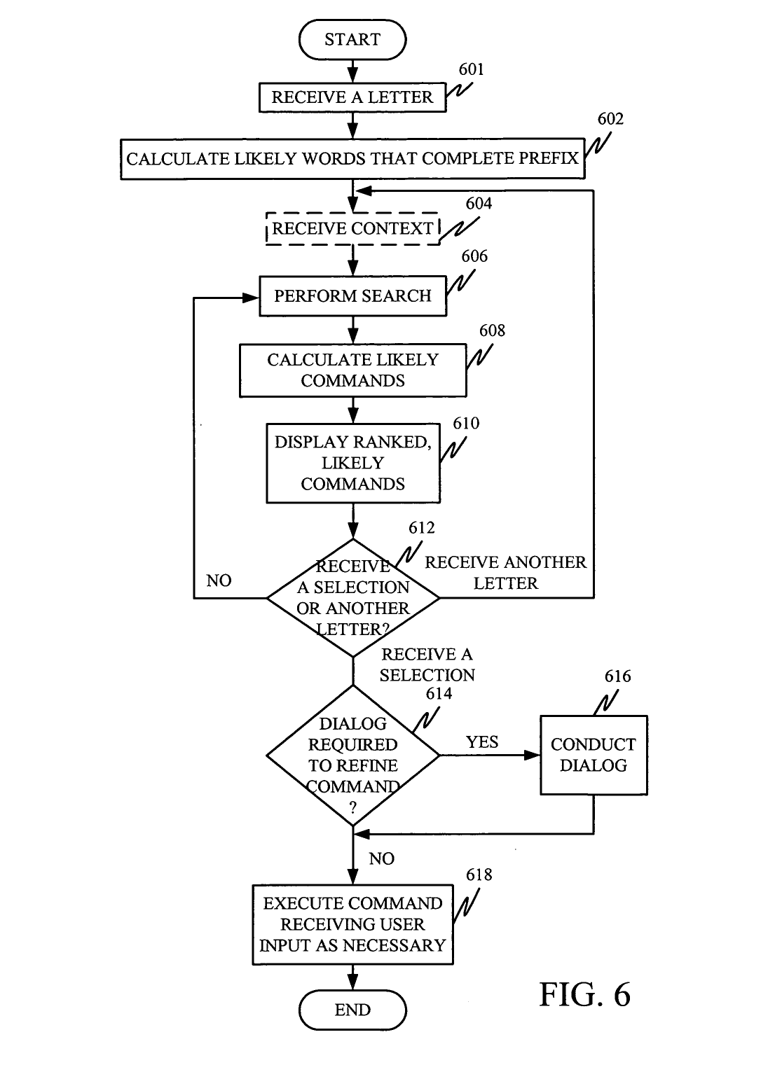

FIG. 6 is a flow diagram illustrating one embodiment of the operation of the system shown in FIG. 5. FIGS. 5 and 6 will now be described in conjunction with one another. For the purposes of this discussion, it is assumed that user 554 launches application 552 and desires to perform a task using application 552. The user illustratively does not know the command or commands required to perform the task. In other words, the user has not memorized the steps necessary (or the location of the user interface elements required) to perform the desired task. Therefore, user 554 must locate the command required to perform the desired task.

In accordance with one embodiment, user 554 begins to enter a search request. In one embodiment, user 554 can enter the search request through speech recognition component 570, by simply speaking the desired search request. For purposes of the present discussion, however, it will be assumed that the user types in the search request one letter at a time, but the invention is not to be so limited.

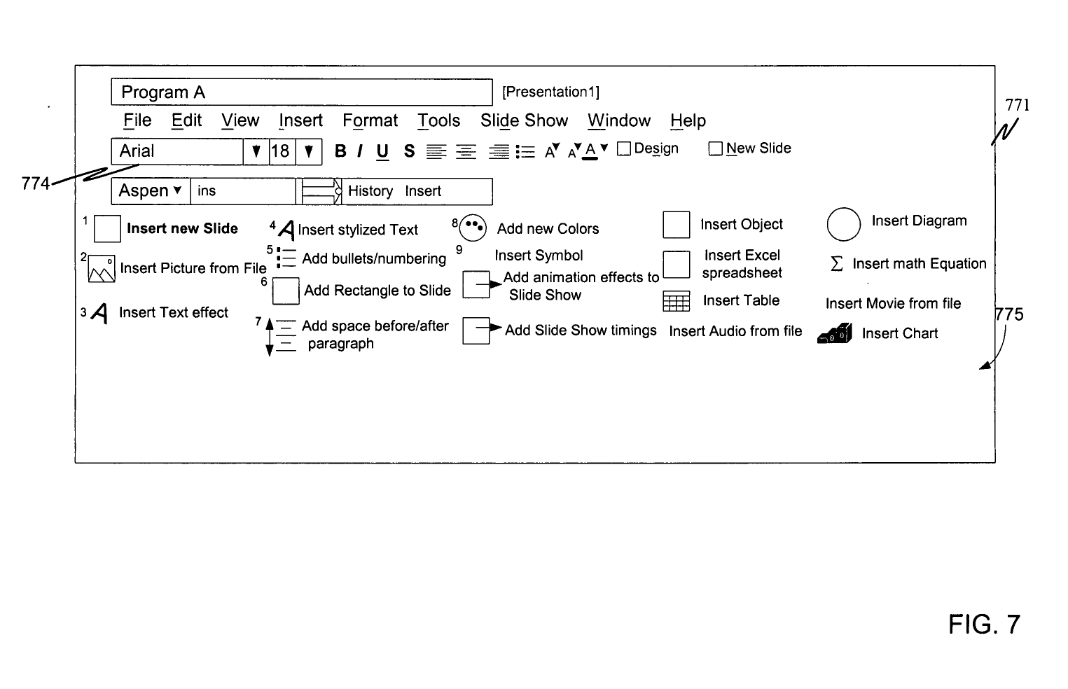

In any case, FIG. 7 shows one graphical user interface 771 that can be used to receive entry of the search request. User interface 771 in FIG. 7 illustrates that application 552 is a presentation program referred to as “Program A”. Command searching and processing component 558 exposes text box 774 through user interface 771 of application 552, to the user. The user can enter a search request, letter by letter, into text box 774.

Therefore, after the user 554 types in a first letter in text box 774 on user interface 771, the letter is transmitted, as a search request 580, to command searching and processing component 558 in platform 556. In order to do this, in one embodiment, application 552 provides the search request 580 through the interface 560 exposed by component 558. Receiving the first letter at command searching and processing component 558 is indicated by block 601 in FIG. 6.

Component 558 then calculates likely words that complete the letter string entered thus far. For instance, if the user has typed “ins” the most likely completion of this prefix might be “insert”. This is indicated by block 602 in FIG. 6 and is described in more detail below with respect to the example shown in FIG. 7.

In one embodiment, component 558 also receives the context 581 of application 552. For instance, the context will illustratively identify the particular application 552 for which a command is sought, and provide an indication of the particular contents of the window currently open and under focus in the application, a position of the cursor relative to the elements on the open window, the features present in the current page of the document (for example: tables, bullets, text, etc), etc. Examples of context 581 are described in greater detail below and the optional step of receiving the context is indicated by block 604 in FIG. 6.

Once the first letter is received, likely completions are calculated, and the searching component 558 performs a search through command store 559 that stores the commands associated with a plurality of different applications. This search is performed based on the received letters, likely completions and the context. Performing the search is indicated by block 606 in FIG. 6.

In performing the search, component 558 identifies possible commands and calculates a score indicative of how likely it is that each of the possible commands is being requested by the user in the search request. This is indicated by block 608 in FIG. 6. While the search can be performed in any desired way, in one embodiment, the search is performed using a search engine that is trained with prior probabilities of commands (e.g., a Naïve bayes classifier, etc.).

Once the calculation has been made, component 558 returns the search results through interface 560 where they are displayed at user interface 771 through application 552. Of course, the results can be returned without going through application 552 as well. In any case, in one embodiment, component 558 not only displays the most likely commands given the search request, but also displays them in ranked order, given the score calculated for each command. Displaying the ranked commands is indicated by block 610 in FIG. 6.

User 554 can then either select one of the displayed commands, or continue typing additional letters in the search request. This is indicated by block 612 in FIG. 6. In the embodiment in which the user does not select one of the commands, but instead continues to type letters, processing reverts back to block 606 and another search is performed, scores are calculated, and the likely commands are again displayed in ranked order, as indicated by blocks 608 and 610.

Assume for the sake of the example shown in FIG. 7 that the user 554 wishes to insert a table in the particular application 552 that is open. In the embodiment shown in FIG. 7, user interface 771 shows that user 554 has typed into text box 774 the letters “ins”. The context has also been provided to component 558. The context indicates, among other things, that the open application 552 is a presentation application. The context may include whether the current slide has a table, picture etc. Component 558 calculates the probabilities of commands associated with the input “ins” stored in command store 559. In the particular example shown in FIG. 7, component 558 determines that the most probable completion of “ins” is “insert”, and component 558 displays, as search results, commands which relate to inserting or adding in the given context.

It will be noted from this example that component 558 illustratively not only searches based upon the particular letters input, but based upon synonyms of the most likely completions of those letters. In other words, the most likely completion of the letters “ins” in the present context is “insert”. Therefore, component 558 identifies synonyms for “insert” (such as “add”) and searches for commands that are for “inserting” or “adding” things and that would be most likely, given the current context of the application 552.

As shown in FIG. 7, component 558 returns the search results, ranking them in order. It can be seen that the first command returned is “insert slide” which is more probable than the other commands in the list. The other commands in the list are rank ordered, according to the score calculated by component 558 (which can be a likelihood or probability or other desired measure) and they are numbered, according to their rank. In the embodiment shown in FIG. 7, the first nine results are numbered to allow for easy keyboard access to launch the command (e.g., keyboard shortcuts).

The user can select one of the commands from the list of returned results 775 by simply clicking on the displayed command. However, in one embodiment, the user can also select one of the numbered search results by simply typing that number in box 774. Any other desired way of selecting a command from the list 775 can be used as well.

In accordance with the example shown in FIG. 7, the user selects the “insert table” command. Having component 558 receive a command selection is indicated by block 612 in FIG. 6.

Once the user has selected a command from list 775, if more dialog with the user is required in order to further refine or disambiguate the command, component 558 can conduct that additional dialog. Determining whether extra dialog is required and conducting that dialog is indicated by blocks 614 and 616 in FIG. 6.

Once the dialog is complete, or if no further dialog is required, that means that the selected command has been fully disambiguated by component 558. Component 558 can then either provide additional information to user 554 about the selected command (such as tutorial information), or component 558 can simply execute the command selected by the user. Executing the selected command is indicated by block 618 in FIG. 6.

As an example of executing the command, where the user has selected the “insert table” command, component 558 (after it determines that no additional dialog is necessary) controls application 552 such that application 552 takes the user to the appropriate place in the application to execute the “insert table” command.

As an example of conducting additional dialog to refine a command, component 558 may conduct a dialog with the user as at block 616 in FIG. 6 to determine the size of the table that the user wishes to add. Component 558 then adds it automatically. In another embodiment, component 558 simply allows the user to walk though the “insert table” functionality provided by application 552, once component 558 has taken the user to that place in the user interface provided by application 552.

In accordance with another embodiment, component 558 (or another component invoked by component 558) automatically performs the command selected by the user, receiving user inputs where necessary. For instance, user 554 can select the desired user interface elements to insert a table from the list 775 of possible commands. Component 558 (or another component invoked by component 558) can then assume control of application 552 and begin to automatically perform that command. However, when it comes to the point where the user interface asks the user to specify the size of the table (in terms of columns and rows) component 558 simply highlights the field to be modified by the user and pauses until the user has input the desired information and clicked “OK”. In that example, component 558 (or other component) simply waits until the user has selected the desired number of columns and rows and clicked “OK” and component 258 (or other component) then walks the application 552 through the remainder of the steps necessary to perform the command of inserting the desired size table within the application, at the specified spot. Automatically executing the command is indicated by block 614 in FIG. 6.

Advertisements can be effectively integrated into applications that, similar to application 552, support searching for commands. In one embodiment, advertisements within such a system are targeted based on the queries that users type in to search for commands and/or based on the commands that the user selects/executes following a search. Applications configured to support command searching are likely to be especially appealing to advertisers because they bring advertisements to the surface through a function (i.e., command searching) that is likely to be appealing to users in terms of providing a natural and simplified user experience.

To create support for the command search functionality, someone (e.g., the developers) will typically associate metadata with a list of commands supported by the application. The metadata, which may include direct indicators, synonyms, related terms and the like is what enables a command to be searched. Thus, in order to support the search functionality, a good searchable record of application commands is generated.

In accordance with one embodiment, advertisers can leverage the same searchable record to find commands of interest for advertising purposes. The same metadata added to support searches by users also makes it searchable by advertisers.

Further, users of an application that supports the command searching architecture will inherently be using certain language to query for commands. Thus, in addition to advertising based on commands, advertisers can illustratively target advertisements based on certain terms used to query commands.

In one embodiment, a software developer that having an application that supports the command searching architecture will receive a list of user queries, and so will be able to identify features that users want that are not currently supported by the application. The developer can then use this knowledge to add more commands to the application in order to satisfy users' wants and needs. This also inherently increases the number of opportunities for advertising (e.g., at least by increasing the number of commands).

In order to provide a better understanding of how a command-searching architecture is beneficial to the described command-advertising schemes, a few specific example scenarios will now be provided. These example scenarios will borrow from, and elaborate upon, the example scenarios previously stated above.

Joe, the end user described above, now wants to edit his photographs again and remembers that he used PhotoEdit 11.0 in the past. He launches that application again and is pleasantly surprised to see that it now supports the command-searching/advertising architecture. He also sees a history of commands that he last performed within the application, including the ad that he clicked to print his photos on a web site associated with “PICTURE-CO-EXPRESS.”

This time, Joe has a lot of photos from his wedding and wants to make a slick slide show with narration to send to his friends and family. He types in “slide show” in the command box (e.g., in a box similar to 774 in FIG. 7). He is presented with (e.g., in a command results are similar to 775) an advertisement for “Create a Slide Show With Photos Using Presenter 3.0,” which is an up sell link for another application. He selects the advertisement (e.g., clicks on it), which cause the Presenter 3.0 application to launch. The Presenter 3.0 application also illustratively supports the command searching/advertising architecture.

Joe then searches for and uses “import photos” and other slide show commands to create his slide show. He then enters “narrate” and see a command in the form of “Record Audio On Each Slide.” When he uses the functionality linked to this command, he notices that the audio quality is very bas as he has a substandard microphone. Next to the “Record Audio On Each Slide” command, he also sees a sponsored command for “Buy a Good Quality Microphone for 30% Discount at GreatAudio.com” and another sponsored command for “Buy Headset at AudioUs.” Joe clocks on the GreatAudio link and proceeds to order a good microphone.

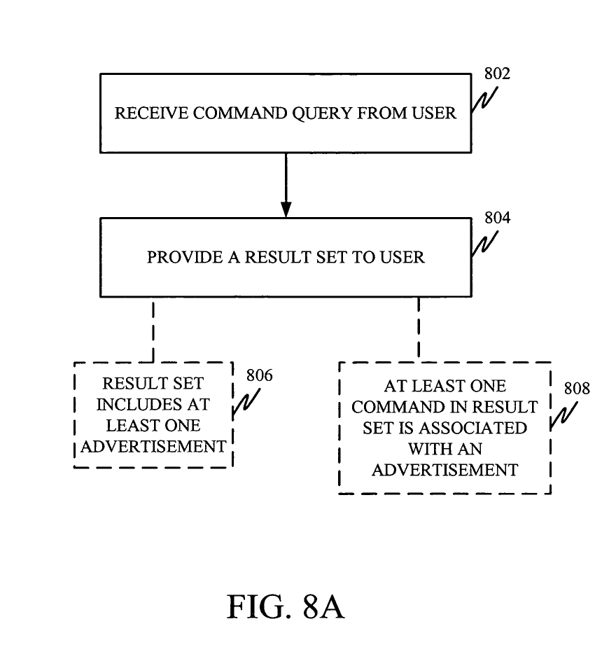

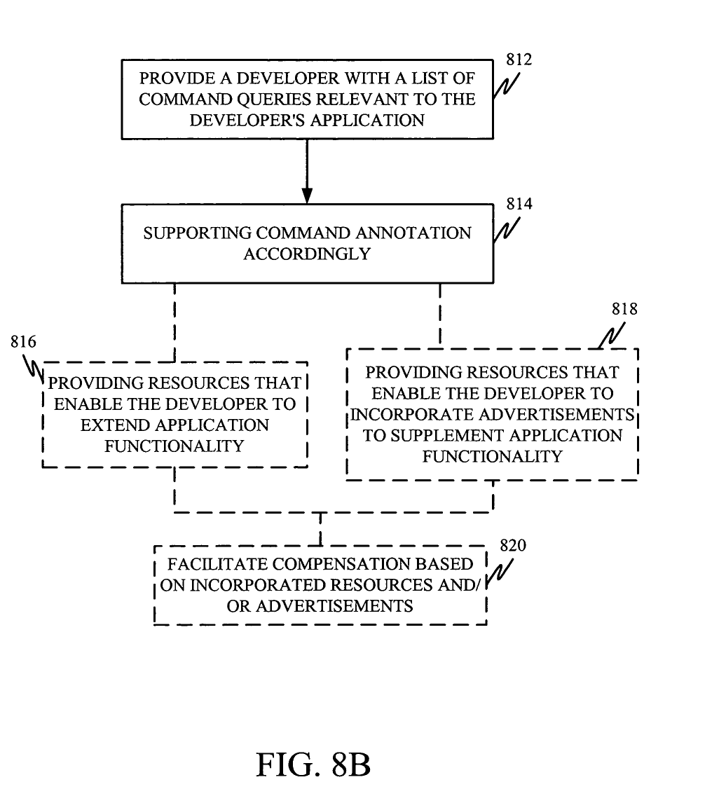

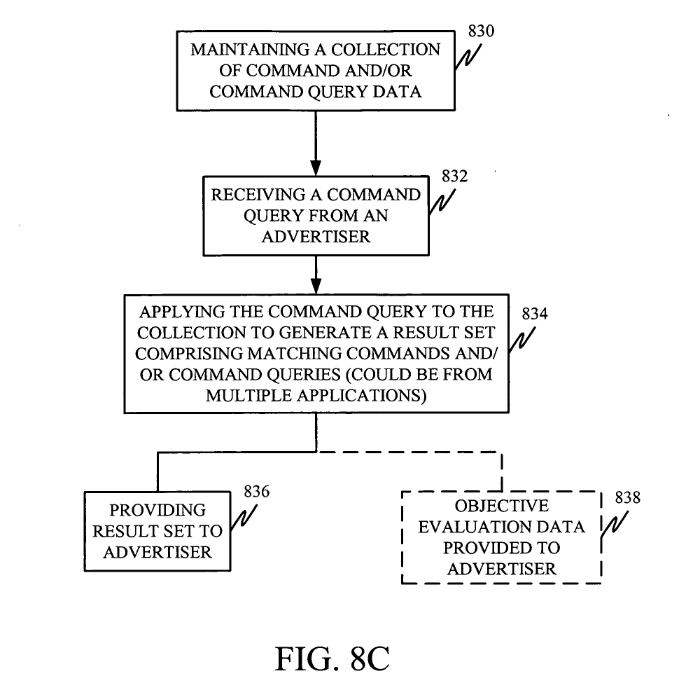

FIG. 8A is a block flow diagram demonstrating, from a system perspective, generalized steps for providing an advertisement within a command-searching architecture. In accordance with block 802, a command query is received from a user. In accordance with block 804, a result set is provided to the user based on the command query. As is indicated by block 806, the result set may include an advertisement that appears in a manner that is similar to the appearance of just another command. In accordance with block 808, at least one command in the result set is associated with a command that appears within the result set, appears only when the command is encountered in a different context, and/or appears upon selection/execution of the underlying command.

In another example scenario, Dave, the developer described above, has now enabled his graphic design application to support the command-searching/advertising architecture. The Application is now called “Graphic Design Editor Deluxe.” Dave is able to use the command-searching functionality to assist him in annotating the commands that his application supports. He also takes advantage of the ability to show sponsored commands in his application.

After a month, Dave looks at query logs (e.g., logs that were automatically generated for Dave and/or provided to him by a sponsor of the command-searching architecture). He notices that many users want to “add video” to their work. Also, one of the most popular user queries for his application is “clipart,” and he doesn't have a professional library of clipart content to provide.

Dave decides to add a link to “VideoExpress” for the video query. For the “clipart” query, he links to Jill's advertisement. Jill's company offers revenue share deal of 20% of the amount that any customer spends through his link.

FIG. 8B is a block flow diagram demonstrating, from a system perspective, generalized steps for enabling a developer to annotate application functionality. In accordance with block 812, a developer is provided with a list of command queries made in the context of the developer's application (e.g., provided by services included within the architecture of centralized advertising component 110). Based on those results, in accordance with block 814, command annotation is supported (e.g., supported by a services included within the architecture of centralized advertising component 110). In accordance with block 816, this means providing (e.g., enabling the developer to purchase) resources that enable the developer to directly extend application functionality. In accordance with block 818, resources are provided to the developer to enable the incorporation of advertisements into the application to supplement application functionality. In accordance with block 820, compensation is facilitated based on incorporated resources and/or advertisements. This may mean the developer being compensated for add placement (CPM, CPC, CPA, Revenue Sharing, etc.), or the developer compensating for an incorporated resource (e.g., a license, a per use license, etc.).

In another example scenario, Jill, the person from the graphic design firm described above, now wants to find users who might be interested in professional images, icons and templates. She accesses a service (e.g., an online service provided within the architecture of centralized advertising component 110) and searches for commands and user queries related to “templates” and “icons.” She finds that there are about 500 user queries a day for “template” on Dave's application. She bids on that keyword for the right to show a sponsored link to her web site where professional templates can be purchased.

FIG. 8C is a block flow diagram demonstrating, from a system perspective, generalized steps for enabling an advertiser to search for advertising opportunities. In accordance with block 830, a collection of data is maintained and includes data related to commands and/or command queries. In accordance with block 832, a command query is received from an advertiser. In accordance with block 834, the command query is applied to the collection of data in order to generate a corresponding result set. The result set includes matching commands and/or command queries. In one embodiment, the searching process is quite flexible in that it leverages the command metadata utilized to support user command searching. In accordance with block 836, the result set is supplied to the advertiser. In accordance with optional block 838, object evaluation data is also supplied to the advertiser to support more informed advertising decisions. The object data might include, but is not limited to, how often a particular command or command query has been encountered or executed within a given application.

In another example scenario, Kim works for a medical software company that makes billing software for doctors and dentists. She accesses a service (e.g., an online service provided within the architecture of centralized advertising component 110) and searches for commands and user queries with which she may want to advertise her company's software. For the query “billing template,” she finds there are about 200 queries a day on an application called “EZ Spreadsheet,” and about 500 per day on an application called “SpreadSheetExpress.” She decides to buy that query for both applications to make it so that her advertisement will appear in response.

In another example scenario, Rick is a home appraiser in Seattle, Wash. He wants to advertise his services to sellers in the area. He accesses a service (e.g., an online service provided within the architecture of centralized advertising component 110) and identifies several real estate applications that are offered by individual software developers as well as real estate companies. he notices that some of them use “Mapping API” to provide satellite images of homes in the area and are very popular with users.

Rick then performs a broad search for commands relevant to “appraisal” and finds that several applications support this feature including one of the most popular local sites “Windermere.” He bids for his ad to be shown whenever a user living in Seattle types “appraisal” or “sell home” in any real estate application supported within the system.

Accordingly, embodiments of the present invention encompass a broad range of command-oriented advertising features. The concept of showing an advertisement targeted to a particular command in an application is included. Also included is the concept of advertisers selecting commands from a directory of advertising-supported applications (e.g., a directory maintained on a network). Also included is the concept of advertisers bidding (e.g., in a real time auction) for a limited opportunity or a ranking spot with respect to other advertisers for a given command. Also included is the concept of advertisers adding affiliate program links for software developers to add to commands in their applications. These are just examples of included features.

Still other features are related to the described command searching architecture. For example, included is the concept of showing an advertisement targeted to what a user has input in a search for a command. Also included is the concept of advertisers searching for commands relevant to their advertising needs. In one embodiment, an advertiser can query for all commands in a database, across all add supported applications, and can rank/sort the results in different ways. Also included is the concept of advertisers bidding (e.g., in a real time auction) for a limited opportunity or a ranking spot for their add relative to a particular command query. Again, these are just examples of included features.

It is worth noting that the terms “software application” or “computer software,” as these and similar terms are used herein, are intended to be broadly construed. These terms are intended to include any application that runs on computer hardware. Further, any computer-implemented code that, upon execution, enables a user to accomplish a task is included. It is also worth noting that, as desktop applications become more web aware, and web applications become richer, the lines between software on the client and software running inside a browser are becoming blurred. Thus, the noted terminology is also intended to encompass software running on a computer or remotely accessed. One example of a remotely application is an application accessed through a local web browser that is configured to run the application on a server in the Internet.

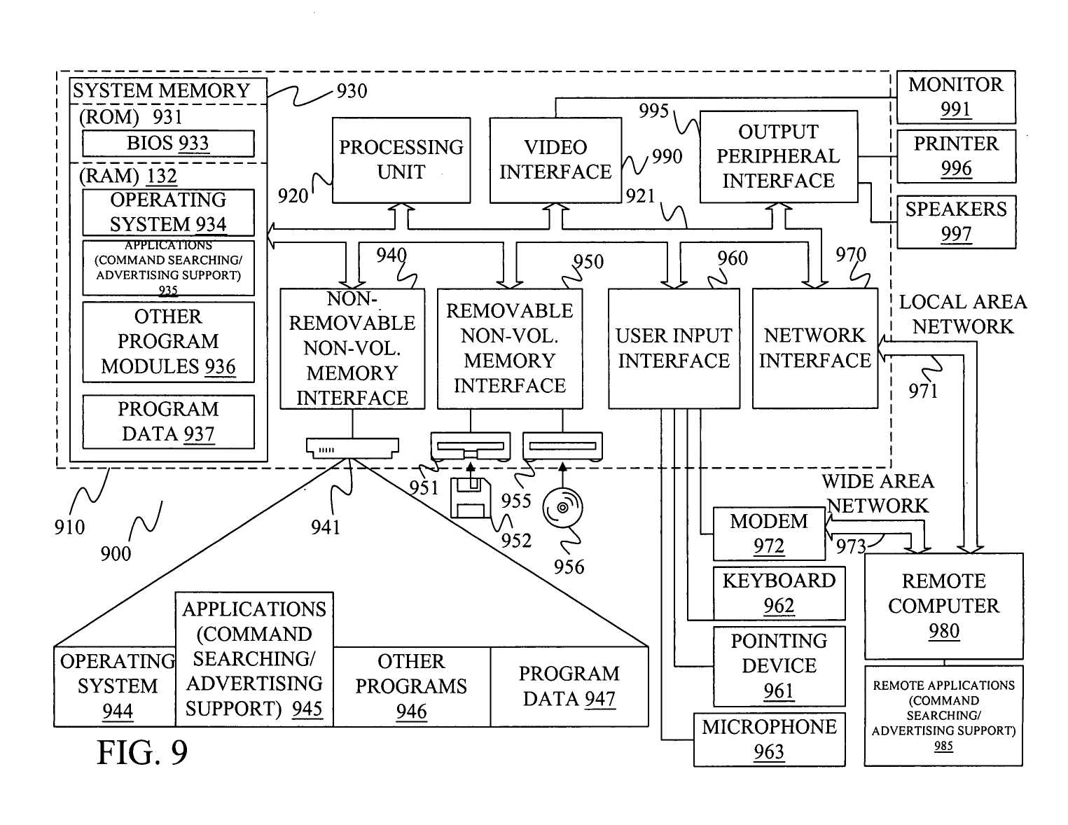

FIG. 9 illustrates an example of a suitable computing system environment 900 in which embodiments may be implemented. The computing system environment 900 is only one example of a suitable computing environment and is not intended to suggest any limitation as to the scope of use or functionality of the claimed subject matter. Neither should the computing environment 900 be interpreted as having any dependency or requirement relating to any one or combination of components illustrated in the exemplary operating environment 900.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 9, an exemplary system for implementing some embodiments includes a general-purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937. Programs 935 are illustrated as being configured to support command-oriented advertising/searching as described herein. This need not necessarily be the case for any or all of the programs. Further, programs 936 can also or alternatively be so configured.

The computer 910 may also include other removable/non-removable volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. Programs 945 are illustrated as being configured to support command-oriented advertising/searching as described herein. This need not necessarily be the case for any or all of the programs. Further, programs 946 can also or alternatively be so configured.

A user may enter commands and information into the computer 910 through input devices such as a keyboard 962, a microphone 963, and a pointing device 961, such as a mouse, trackball or touch pad. Other input devices (not shown) may include a joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 is operated in a networked environment using logical connections to one or more remote computers, such as a remote computer 980. The remote computer 980 may be a personal computer, a hand-held device, a server, a router, a network PC, a peer device or other common network node, and typically includes many or all of the elements described above relative to the computer 910. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on remote computer 980. It will be appreciated that the network connections shown are exemplary and other means of establishing a communications link between the computers may be used. Programs 985 are illustrated as being configured to support command-oriented advertising/searching as described herein. This need not necessarily be the case for any or all of the programs.

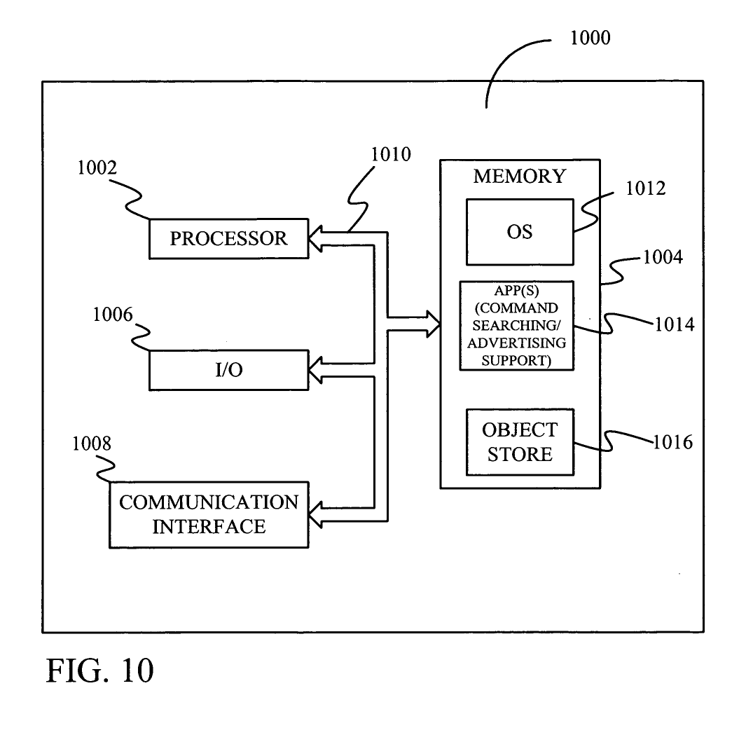

FIG. 10 is a block diagram of a mobile device 1000, which is an exemplary computing environment. Mobile device 1000 includes a microprocessor 1002, memory 1004, input/output (I/O) components 1006, and a communication interface 1008 for communicating with remote computers or other mobile devices. In one embodiment, the afore-mentioned components are coupled for communication with one another over a suitable bus 1010.

Memory 1004 is implemented as non-volatile electronic memory such as random access memory (RAM) with a battery back-up module (not shown) such that information stored in memory 1004 is not lost when the general power to mobile device 1000 is shut down. A portion of memory 1004 is illustratively allocated as addressable memory for program execution, while another portion of memory 1004 is illustratively used for storage, such as to simulate storage on a disk drive.

Memory 1004 includes an operating system 1012, application programs 1014 as well as an object store 1016. Programs 1014 are illustrated as being configured to support command-oriented advertising/searching as described herein. This need not necessarily be the case for any or all of the programs. During operation, operating system 1012 is illustratively executed by processor 1002 from memory 1004. Operating system 1012 is illustratively designed for mobile devices, and implements database features that can be utilized by applications 1014 through a set of exposed application programming interfaces and methods. The objects in object store 1016 are maintained by applications 1014 and operating system 1012, at least partially in response to calls to the exposed application programming interfaces and methods.

Communication interface 1008 represents numerous devices and technologies that allow mobile device 1000 to send and receive information. The devices include wired and wireless modems, satellite receivers and broadcast tuners to name a few. Mobile device 1000 can also be directly connected to a computer to exchange data therewith. In such cases, communication interface 1008 can be an infrared transceiver or a serial or parallel communication connection, all of which are capable of transmitting streaming information.

Input/output components 1006 include a variety of input devices such as a touch-sensitive screen, buttons, rollers, and a microphone as well as a variety of output devices including an audio generator, a vibrating device, and a display. The devices listed above are by way of example and need not all be present on mobile device 1000. In addition, other input/output devices may be attached to or found with mobile device 1000.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer application configured to:
detect when a user has encountered a particular command element; and
provide an advertisement as an alternative to executing the command associated with the command element.

2. The computer application of claim 1, wherein the application is further configured to facilitate pursuit of a product or service offered by a sponsor of the advertisement.

3. The method of claim 1 further comprising detecting when the command element has been selected for execution, wherein providing an advertisement then comprises presenting to the user an advertisement that is related to execution of the command.

4. The method of claim 1, wherein detecting when the user has encountered a particular command element comprises:
receiving a command query from a user; and
responding to the command query by providing a corresponding result set that includes the command element.

5. The method of claim 1 further comprising facilitating pursuit of a product or service offered by a sponsor of the advertisement.

6. A computer-implemented advertisement component that is configured to facilitate a linking of commands to advertisements within a software application.

7. The computer-implemented advertising component of claim 6, wherein the component is configured to link advertisements associated with multiple advertisers to commands within the software application.

8. The computer-implemented advertising component of claim 6, wherein the component is configured to provide a sponsor of the software application with a listing of advertisements that can be linked to a command within the application.

9. The computer-implemented advertising component of claim 8, wherein the component is configured to facilitate compensation of the sponsor for ad placement within the application.

10. The computer-implemented advertising component of claim 9, wherein the component is configured to facilitate compensation in accordance with a plurality of different compensation models.

11. The computer-implemented advertising component of claim 6, wherein the component is configured to provide an advertiser with a listing of commands associated with the application.

12. The computer-implemented advertising component of claim 6, wherein the component is configured to provide an advertiser with a listing of commands associated with multiple applications.

13. The computer-implemented advertising component of claim 6, wherein the component is configured to provide an advertiser with objective criteria for evaluating advertising appeal of a given command or application.

14. The computer-implemented advertising component of claim 6, wherein the component is configured to receive a command query from an advertiser.

15. The computer-implemented advertising component of claim 6, wherein the component is configured to provide a result set of commands to an advertiser based on a corresponding command query.

16. The computer-implemented advertising component of claim 6, wherein the component is configured to provide an advertiser with information related to query terms utilized within an application to query commands.

17. The computer-implemented advertising component of claim 6, wherein the component is configured to enable multiple advertisers to bid on an advertising right related to a command.

18. A computer-implemented method for linking advertisements to commands within software applications, the method comprising:
receiving a command query from an advertiser; and
providing, based on the command query, a result set to the advertiser.

19. The method of claim 18, wherein providing a result set comprises providing an indication of at least one query term utilized by users to query commands.

20. The method of claim 17, wherein providing a result set comprises providing an indication of a plurality of commands associated with a plurality of applications.
